(19) United States
(12) Patent Application Publication
(10) Pub. No.: US 2019/0016296 A1
(43) Pub. Date: Jan. 17, 2019

(54) SEAT BELT CUTTER

(71) Applicant: Jeromy Daniel, Woodhaven, NY (US)

(72) Inventor: Jeromy Daniel, Woodhaven, NY (US)

(21) Appl. No.: 15/651,532

(22) Filed: Jul. 17, 2017

(51) Int. Cl. B60R 22/32; B26B 27/00

(52) U.S. Cl. CPC B60R 22/32; B60R 2022/328; B26B 27/007

(57) ABSTRACT

A seat belt cutter includes a body. The body has a slot and a channel each formed along the length. A pull arm is slidably engaged within the channel. The pull arm includes a first end and a second end. A blade protrudes from the first end and into the slot. The second end of the pull arm includes a handle disposed outside of the body.

### BACKGROUND OF THE INVENTION

The present invention relates to a seat belt cutter and, more particularly, to a seat belt cutter directly attached to a seat belt or as an original equipment manufacturer attached within the vehicle.

A seat belt cutter is a tool having a razor blade recessed in plastic. A seat belt cutter is used to cut seat belts or other restrictions during an emergency. Currently, a seat belt cutter may not be readily available during an emergency, which may prevent a rescue dispatcher or other rescuer from saving a person in distress.

As can be seen, there is a need for an improved seat belt cutter directly attached to a seat belt.

### SUMMARY OF THE INVENTION

In one aspect of the present invention, a seat belt cutter comprises: a body comprising a slot and a channel each formed along a length of the body; and a pull arm slidably engaged within the channel and comprising a first end and a second end, wherein the first end comprises a blade protruding into the slot and the second end comprises a handle disposed outside of the body.

In another aspect of the present invention, a method of cutting a seatbelt comprises the steps of: providing a seat belt cutter comprising: a body comprising a slot and a channel each formed along a length of the body; and a pull arm slidably engaged within the channel and comprising a first end and a second end, wherein the first end comprises a blade protruding into the slot and the second end comprises a handle disposed outside of the body; securing the seat belt cutter to a seat belt by inserting the seat belt into the slot; and pulling the handle so that the pull arm slides along the channel, the blade travels along the slot and cuts the seat belt.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention shown in use;

FIG. 3 is a perspective view of an embodiment of the present invention shown in use;

FIG. 4 is a perspective view of an embodiment of the present invention;

FIG. 5 is a side view of an embodiment of the present invention illustrated in an initial configuration;

FIG. 6 is a side view of an embodiment of the present invention illustrated in a secondary configuration; and

FIG. 7 is a section detail view of the present invention taken along line 7-7 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

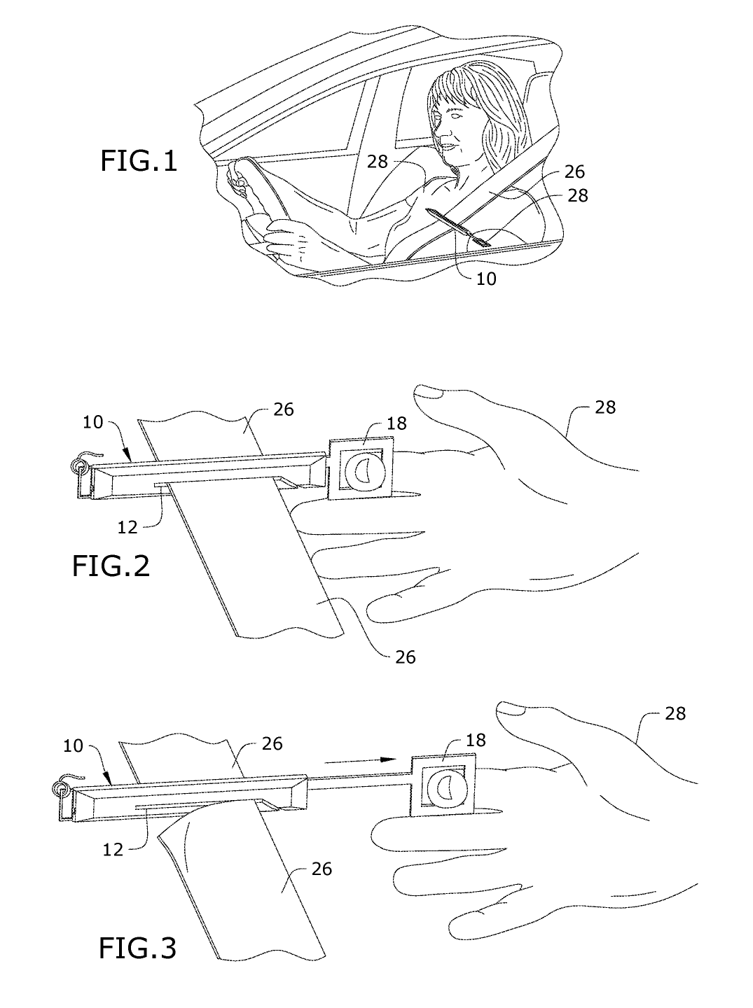

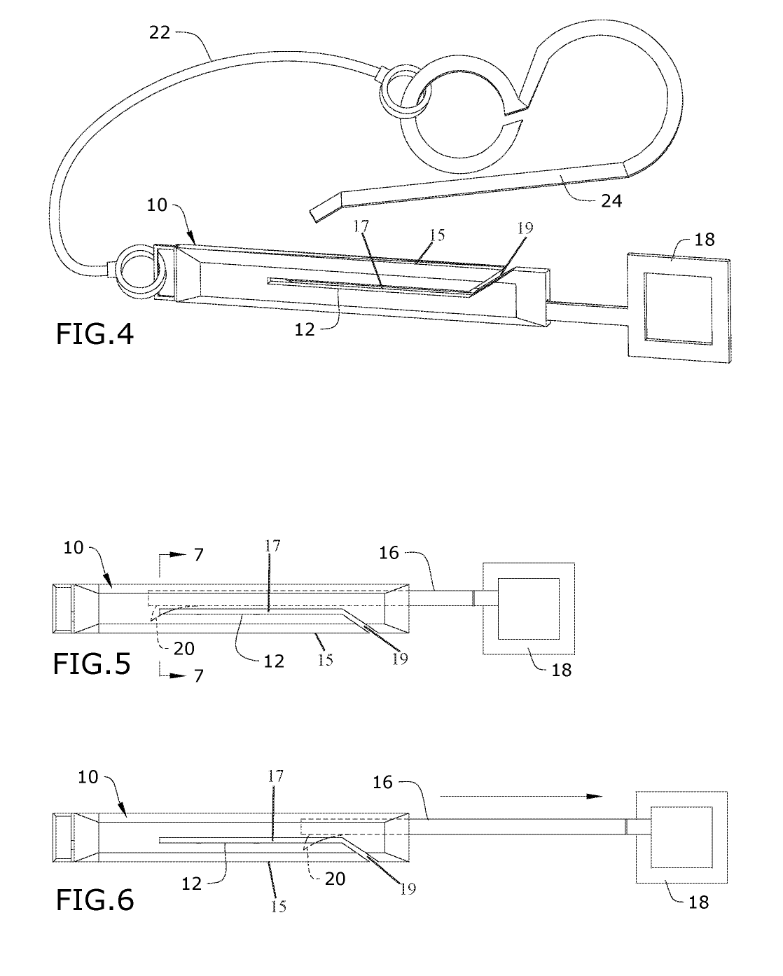

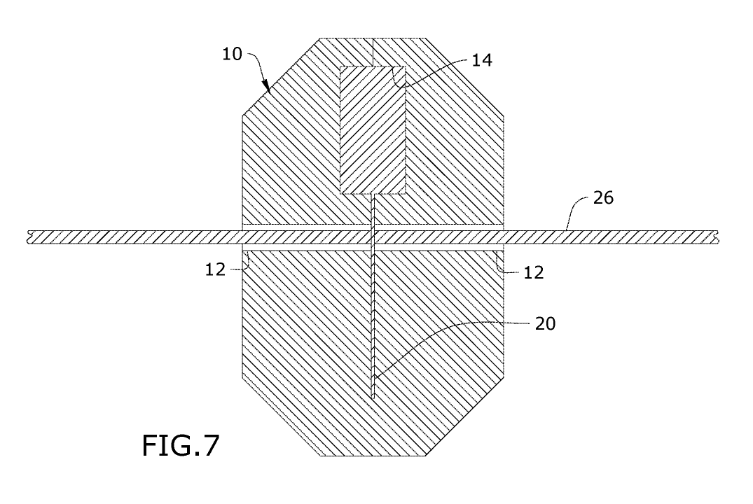

Referring to FIGS. 1 through 7, the present invention includes a seat belt cutter. The seat belt cutter includes a body 10. The body 10 has a slot 12 and a channel 14 each formed along the length. A pull arm 16 is slidably engaged within the channel 14. The pull arm 16 includes a first end and a second end. A blade 20 protrudes from the first end and into the slot 12. The second end of the pull arm 16 includes a handle 18 disposed outside of the body 10.

The body 10 may be made of a fire-resistant polymer or metal. The body 10 of the present invention includes a first end, a second end, a first side, a second side, an outer edge and the length from the first end to the second end. The slot 12 is formed through the first side and the second side. The slot 12 includes a main portion formed along the length and an entrance formed from the outer edge of the body 10 to the main portion. The channel 14 is formed along the length adjacent to the main portion of the slot 12. The channel 14 may be substantially parallel relative to the slot 12. An opening is formed at the first end of the body 10 leading into the channel. The channel 14 may be formed in between the first side, the second side and the outer edge. When the pull arm 16 is pulled to slide within the channel 14, the blade 20 runs from an end of the main portion of the slot 12 to the entrance of the slot 12.

The pull arm 16 of the present invention includes an elongated body slidably disposed within the channel 14. The blade 20 protrudes from the end of the elongated body and is substantially perpendicular to the elongated body. The blade 20 includes a sharpened edge that slides along the slot 12. The blade 20 may be metal, such as a razor blade. The handle 18 is a looped ring configured to receive a finger of a user 28 within. In certain embodiments, the present invention includes a cord 22 attached to an end of the body 10. A hook 24 is attached to the cord 22. The hook 24 may releasably attach to a seat belt top loop or ring.

A method of cutting a seatbelt may include the following steps of: providing a seat belt cutter as described above; securing the seat belt cutter to a seat belt 26 by inserting the seat belt 26 into the slot 12; and pulling the handle 18 so that the pull arm 16 slides along the channel 14, the blade 20 travels along the slot 12 and cuts the seat belt 26.

It should be understood, of course, that the foregoing relates to exemplary embodiments of the invention and that modifications may be made without departing from the spirit and scope of the invention as set forth in the following claims.

1. A seat belt cutter comprising:
a body comprising a first end, a second end, a first side, a second side, an outer edge comprising a top edge and a bottom edge, a length from the first end to the second end, a slot and a channel each formed along the length of the body, wherein the slot is formed through the first side and the second side, the slot comprising a main portion formed along the length and an entrance having an opening at the bottom edge and angled to join with the main portion; and
a pull arm slidably engaged within the channel and comprising a first end and a second end, wherein the first end comprises a blade protruding into the slot and the second end comprises a handle disposed outside of the body.

2. (canceled)

3. The seat belt cutter of claim 1, wherein the channel is formed along the length adjacent to the main portion of the slot, wherein an opening is formed at the first end of the body leading into the channel.

4. The seat belt cutter of claim 3, wherein the channel is formed in between the first side and the second side.

5. The seat belt cutter of claim 1, wherein when the pull arm is pulled to slide within the channel, the blade runs from an end of the main portion of the slot to the entrance of the slot.

6. The seat belt cutter of claim 1, wherein the handle is a looped ring configured to receive a finger within.

7. The seat belt cutter of claim 1, further comprising a cord attached to an end of the body, and a hook attached to the cord.

8. A method of cutting a seat belt comprising the steps of:
providing a seat belt cutter comprising:
a body comprising a first end, a second end, a first side, a second side, an outer edge comprising a top edge and a bottom edge, a length from the first end to the second end, a slot and a channel each formed along the length of the body, wherein the slot is formed through the first side and the second side, the slot comprising a main portion formed along the length and an entrance having an opening at the bottom edge and angled to join with the main portion; and
a pull arm slidably engaged within the channel and comprising a first end and a second end, wherein the first end comprises a blade protruding into the slot and the second end comprises a handle disposed outside of the body;
securing the seat belt cutter to a seat belt by inserting the seat belt into the slot; and
pulling the handle so that the pull arm slides along the channel, the blade travels along the slot and cuts the seat belt.

9. The method of claim 8, wherein the seat belt cutter further comprises a cord attached to an end of the body, and a hook attached to the cord.
